(19) United States
(12) Patent Application Publication
(10) Pub. No.: US 2017/0259299 A1
(43) Pub. Date: Sep. 14, 2017

(54) OPTICAL EFFECT COATING FOR LEATHER AND OTHER ARTICLES

(71) Applicants: Jeffrey D. Miller, Canton, MI (US); Daniel W. Lough, Canton, MI (US); Steven D. Jarrett, Northville Township, MI (US); Roger A. Pinto, Troy, MI (US)

(72) Inventors: Jeffrey D. Miller, Canton, MI (US); Daniel W. Lough, Canton, MI (US); Steven D. Jarrett, Northville Township, MI (US); Roger A. Pinto, Troy, MI (US)

(21) Appl. No.: 15/428,103

(22) Filed: Feb. 8, 2017

Related U.S. Application Data
(60) Provisional application No. 62/292,555, filed on Feb. 8, 2016.

(51) Int. Cl. B05D 5/06; G02F 1/00; B05D 3/00

(52) U.S. Cl. CPC B05D 5/06; B05D 3/20; G02F 1/0036

(57) ABSTRACT

An article includes a substrate and an optical effect coating disposed on the substrate. The optical effect coating includes particles of a magnetically responsive material disposed in a polymer. At least a portion of the particles in a localized region of the optical effect coating are commonly oriented to produce an optical effect at the localized region.

### CROSS-REFERENCE TO RELATED APPLICATION

The present disclosure claims priority to U.S. Provisional Patent Application No. 62/292,555, filed Feb. 8, 2016.

### BACKGROUND

Leather, fabrics, and other goods are often treated to enhance appearance. One such treatment includes application of a coating or paint. While paints are quite commonly used, there is limited ability to enhance paint, especially for complex patterning or special effects.

### SUMMARY

An article according to an example of the present disclosure includes a substrate and an optical effect coating disposed on the substrate. The optical effect coating includes particles of a magnetically responsive material disposed in a polymer. At least a portion of the particles in a localized region of the optical effect coating are commonly oriented to produce an optical effect at the localized region. Also disclosed is a process for fabricating such an article.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example article that has an optical effect coating.

FIG. 2 illustrates a coating that has an optical pattern of circular shapes.

FIG. 3 illustrates a coating that has an optical pattern of rectangular shapes.

FIG. 4A illustrates a sectioned view of a localized region in which magnetically responsive material in a coating is commonly oriented.

FIG. 4B illustrates a sectioned view of a localized region in which magnetically responsive material in a coating is not commonly oriented.

FIG. 5 illustrates an example process for fabricating an optical effect coating.

FIG. 6 illustrates an isolated view of the magnetic template for fabricating an optical effect coating.

FIG. 7 illustrates an example of a particle of a magnetically responsive material that includes a carrier particle and a magnetic material attached to the surface of the carrier particle.

### DESCRIPTION

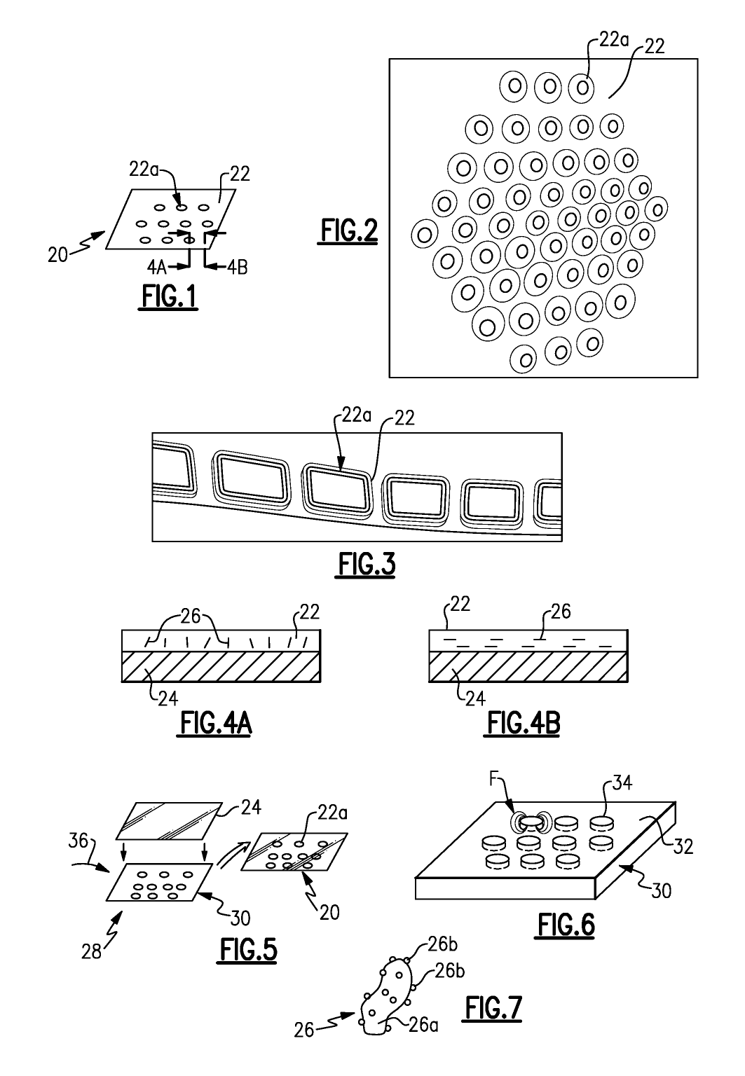

FIG. 1 schematically illustrates an example article 20 that has an optical effect coating 22. For example, the coating 22 includes an optical pattern 22a that is configured to interact with (e.g., reflect, diffuse, etc.) light to provide a three-dimensional visual effect. Further examples of the coating 22 and optical patterns 22a are shown in FIGS. 2 and 3. In FIG. 2 the coating 22 has an optical pattern 22a of circular shapes with an appearance of depth; and in FIG. 3 the coating 22 has an optical pattern 22a of rectangles with an appearance of depth. As will be appreciated from this disclosure, the optical pattern 22a can be varied to almost any shape.

FIG. 4A illustrates a sectioned view according to the section line indicated in FIG. 1. In this example, the coating 22 is disposed on a substrate 24. In particular, the substrate 24 may be a leather product or synthetic leather product. However, other types of substrates may also benefit from the examples herein, such as but not limited to, construction materials (e.g., drywall), fabrics, polymers, and other non-ferromagnetic substrates.

In one example, the coating 22 is a polymer-based coating, such as a paint. For instance, the base polymer of the paint may be, but is not limited to, aliphatic polyurethanes, polyethers, polyesters, and acrylic dispersions (anionic and cationic).

The coating 22 includes particles of a magnetically responsive material 26. For example, the magnetically responsive material 26 is distributed through the polymer of the coating 22. The magnetically responsive material 26 generally includes materials that have paramagnetic or ferromagnetic properties. The magnetically responsive material 26 may include particles. The particles may include, but are not limited to, metallic forms of iron and cobalt. In one example, the coating 22 includes from 5% to 20% by weight of the magnetically responsive material 26, with the remainder being the polymer and any binders, fillers, or other additives in the polymer.

The particles of the magnetically responsive material 26 may contain only the magnetic material or may contain a composite of magnetic material and other material. For example, the composite of the magnetic material may include the magnetic material attached with a non-magnetic material or less magnetic material. In one example as shown in FIG. 6, the magnetically responsive material 26 includes a carrier particle 26a and magnetic material 26b attached on the surface of the carrier particle 26a. The carrier particles (or alternatively the magnetic material) may be high-aspect particles that have an aspect ratio of greater than one, which facilitates the generation of the three-dimensional effect. One example type of carrier particles are mineral particles, such as silicate mineral particles (e.g., mica). Although not specifically limited, the particles of the magnetically responsive material 26 may have an average size of 100 micrometers or less.

In particular, for a substrate 24 of leather, the polymer of the coating 22 may be selected to enhance the leather, or at least avoid substantially debiting the leather. For instance, the polymer may be of a chemistry that cohesively bonds with the leather, has a molecular weight, structure, and cross-link density that maintains flexibility and resists cross-linking that may increase hardness, has good solvent and chemical resistance, has good permeability, can be applied with good repeatability, and has low VOC emissions.

Additionally, the polymer of the coating has a relatively low glass transition temperature, to maintain flexibility even if exposed to low environmental temperature. As an example, the glass transition temperature is 0° C. or lower. In further examples, the glass transition temperature is no greater than −20° C., or is no greater than −30° C.

Additionally, the magnetically responsive material 26 may be inert or may have low chemical reactivity with the polymer of the coating 22. For instance, the magnetically responsive material 26 has few or no chemical functional groups that react with the polymer under temperatures up to the maximum processing temperature, (described more below). Such reactions, if the magnetically responsive material 26 and polymer were to be incompatible and thus reactive with each other, may lead to cross-linking of the polymer. In turn, the cross-linking would increase hardness and rigidity of the polymer, thereby making the film less flexible or even unsuitable for meeting performance criteria of leather.

Somewhat similarly, the magnetically responsive material 26 has few or no chemical functional surface groups. For instance, a portion of the magnetically responsive material 26 may be exposed at the free surface of the coating 22. If subsequent layers or films are applied in the coating 22, such groups may react with those layers or films.

As an example, one indicator of surface reactivity of a functional group is molecular surface area of a unit crystallographic structure of the magnetically responsive material 26. For instance, for a unit cubic structure that has atoms situated at the corners of the cubes, the molecular surface area would be the square of the length of a side of the cube. Here, the molecular surface area of the magnetically responsive material 26 is less than 20×10⁻²⁰ square meters. In a further example, the molecular surface area of the magnetically responsive material 26 is less than 10×10⁻²⁰ square meters. Molecular surfaces areas substantially larger than these may generate or be more prone to functional group reactivity in comparison to areas in the disclosed range. For example, constituent carbonyl groups or highly polar hydrophilic groups of the magnetically responsive material 26 may react with polyisocyanate or carbodiimides (leading to crosslinking) or secondarily bond with water or other groups that debit performance or processing.

In one further example, the magnetically responsive material 26 has a molecular structure that is trigonal bypyramid and has an aspect ratio (w/l) of 3.15 angstom/3.64 angstrom, which is equal to 0.865. This is one example molecular structure that enables the material 26 to be magnetically responsive and reorient along a magnetic field lines.

The potential for surface reactivity can be suppressed via controlling the composition of the coating 22. For instance, at high concentrations of the magnetically responsive material 26 in the coating 22, more of the magnetically responsive material 26 is likely to be exposed at the surface of the coating 22. One indicator of such exposure relates to volume concentration (VC) of the magnetically responsive material 26 versus a critical volume concentration (CVC). The VC is the ratio of the volume of magnetically responsive material 26 in the coating 22 to the volume of the coating. The magnetically responsive material 26 may be considered a pigment, and the VC may thus refer to the ratio with regard to the pigments in the coating 22. The CVC is the ratio at which the amount of polymer exceeds a threshold amount of polymer to fill the voids between particles of the magnetically responsive material 26. That is, below the threshold amount, the particles agglomerate with voids of no polymer there between. The ratios of VC and CVC may be determined by microscopic inspection and measurement. To suppress the potential for surface reactivity, a further ratio of CV to CVC is controlled. For example, the coating has a ratio CV/CVC that is from 0.1 to 0.2. Such as ratio ensures that there is a balance between having enough of the magnetically responsive material 26 for producing the 3D effect and having too much of the magnetically responsive material 26 that there is substantial potential for surface reactivity.

The cross-section depicted in FIG. 4A is taken through a portion of the optical pattern 22a that provides the three-dimensional effect, and the cross-section depicted in FIG. 4B is taken through a portion of the coating 22 that provides no three-dimensional effect. At the location in FIG. 4A the coating 22 locally interacts with light in a different way than at the location shown in FIG. 4B. This difference in how the light interacts with the coating 22 derives from how the magnetically responsive material 26 is oriented in each location.

For instance, in FIG. 4A the particles 26 are generally perpendicular to the plane of the outer surface of the coating 22, while in FIG. 4B the particles 26 are oriented differently (e.g., generally parallel to the outer surface, random, etc.). As will be appreciated, not every particle 26 need be aligned in a perfectly perpendicular orientation, and many, most, or even all of the particles may be oriented at oblique angles to the outer surface of the coating 22. However, at a minimum, the particles 26 in FIG. 4A have a greater degree of perpendicularity than the particles 26 in FIG. 4B. Thus, light that impinges on the portion of the coating 22 where the particles 26 are oriented as in FIG. 4A reflects and diffuses differently than light that impinges on the portion of the coating 22 where the particles 26 are oriented differently. The light interaction at the portion of the coating 22 as in FIG. 4A thus produces the three-dimensional optical effect.

FIG. 5 illustrates an example process 28 for fabricating the article 20. In this example, the substrate 24 is positioned on or near a magnetic template 30 such that one side (back side) of the substrate 24 faces toward or is in contact with the magnetic template 30, and the paint or coating material with the particles 26 is applied to the exposed side of the substrate 24.

FIG. 6 shows an isolated view of the magnetic template 30. The magnetic template 30 includes a non-ferromagnetic support 32 and one or more magnetic elements 34 held in the support 32. For example, the magnetic elements 34 are permanent magnets. The magnetic elements 34 are recessed in the support 32 such that the exposed surfaces of the magnetic elements 34 are flush or substantially flush with the surface of the support 32. The magnetic elements 34 are most typically commonly oriented with regard to their north and south poles. For example, all of the north poles face out from the support 32. Alternatively, one or more of the magnetic elements 34 are differently oriented. For example one or more magnetic elements 34 are oriented with the north pole facing out from the support 32 and one or more other magnetic elements 34 are oriented with the south pole facing out from the support 32. The orientation of the poles may be used to influence the optical pattern 22a in that there is an interaction between magnetic fields of adjacent magnetic elements 34.

The geometry and arrangement of the magnetic elements 34 in the template 30 controls the resulting optical pattern 22a. In this example, the magnetic elements 34 are magnetic disks that are inset into the support 32, and the resulting optical pattern 22a is the pattern shown in FIG. 2. Alternatively, the magnetic elements 34 may be rectangular to produce the optical pattern 22a in FIG. 3. As will be appreciated given this disclosure, other geometries or combinations of geometries of magnetic elements 34 could be used.

The magnetic elements 34 each produce a magnetic field, represented at F. The magnetic field penetrates through the back side of the substrate 24, i.e., the substrate is non-ferromagnetic, such that on the opposite front side of the substrate 24 the magnetic field orients the magnetically responsive material 26 during the process 28. In this regard, different geometries and pole orientations of magnetic elements 34 can be used to provide different magnetic field shapes and, ultimately, different optical patterns 22a.

Turning again to FIG. 5, after positioning the substrate 24 on or near the magnetic template 30, a coating material is applied to the front side of the substrate 24, as represented at 36. Paints or other viscous coating materials may be sprayed onto the substrate 24. In one example, the spraying is conducted at ambient temperature (e.g., 20-25° C.) in air. However, it will be appreciated from this disclosure that the technique for applying the coating material is not necessarily limited to spraying and may be selected based upon the particular coating material. However, in particular for leather or other flexible type of substrate 24, a controlled amount of the coating material may be applied to maintain flexibility, yet provide good surface coverage with relatively few defects. For instance, the coating material is applied in a controlled thickness. To maintain flexibility, the thickness of the applied coating material is controlled to produce a final coating thickness of the coating 22 of 5 micrometers to 40 micrometers. For coating compositions described herein, this may be a dry coating weight of 0.5 to 2.0 (dry) grams solids per square foot. At greater thicknesses or dry weights than above, the coating 22 may become too rigid to meet performance standards for leather. At lower thicknesses or dry weights than above, the coating 22 mat not fully cover the substrate 24 and may not meet quality or defect standards.

The coating material includes the magnetically responsive material 26. For example, by weight, the coating material may contain up to 50% of the magnetically responsive material 26. More typically, the coating material may include 20% or less of the magnetically responsive material 26. During application of the coating material, the magnetically responsive material 26 orients with the magnetic field F of the magnetic elements 34. However, until the coating material cures, the magnetically responsive material 26 may relax to a non-oriented or less oriented state if the magnetic template 30 and magnetic fields are removed. As used herein, the term “cure” or variations thereof refers to drying, solidifying, cross-linking, or other mechanism that rigidizes the polymer and locks the magnetically responsive material 26 in the common orientation. Therefore, in the process 28 the substrate 24, with the coating material applied on the front side, is maintained in position on or near the magnetic template 30 until the coating material cures. The extent of curing can be determined by known testing procedures.

For waterborne paints or other solvent-based viscous coating materials, drying/curing may be accelerated in a drying chamber with application of heat. For instance, the magnetic template 30 and substrate 24 are placed into a heating chamber until the coating material dries to form the coating 22. In one example, the substrate 24 and the magnetic template 30 are secured together, using fasteners or the like, so that the substrate 24 does not shift position on the magnetic template during application of the coating material and/or handling for placement into the heating chamber. If heated drying or curing is used, the temperature should be less than the Curie temperature of the magnetic elements 34. Otherwise, the magnetic elements 34 may cease to provide the magnetic fields and the magnetically responsive material 26 may relax to a non-oriented or less oriented state.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. An article comprising:
a substrate;
an optical effect coating disposed on the substrate, the optical effect coating including particles of a magnetically responsive material disposed in a polymer, and at least a portion of the particles in a localized region of the optical effect coating are commonly oriented.

2. The article as recited in claim 1, wherein the substrate is flexible.

3. The article as recited in claim 1, wherein the substrate is leather.

4. The article as recited in claim 3, wherein the particles of the magnetically responsive material include at least one of iron or cobalt.

5. The article as recited in claim 4, wherein the optical effect coating has, by weight, from 5% to 20% of the particles of the magnetically responsive material.

6. The article as recited in claim 5, wherein the optical effect coating has a thickness from 5 micrometers to 40 micrometers.

7. The article as recited in claim 6, wherein the optical effect coating has a ratio of concentration volume of the particles to a critical concentration volume of the particles that is from 0.1 to 0.2.

8. The article as recited in claim 1, wherein the optical effect coating has a ratio of concentration volume of the particles to a critical concentration volume of the particles that is from 0.1 to 0.2.

9. The article as recited in claim 1, wherein the polymer is selected from the group consisting of polyurethane, polyether, polyester, acrylic, and combinations thereof.

10. The article as recited in claim 9, wherein the polymer is acrylic.

11. The article as recited in claim 1, wherein the polymer has a glass transition temperature that is less than or equal to −0° C.

12. The article as recited in claim 1, wherein the particles of a magnetically responsive material include carrier particles and magnetic material attached on surfaces of the carrier particles.

13. A process comprising:
moving a substrate into proximity of a magnetic template such that a first side of the substrate faces the magnetic template and a second side faces away from the magnetic template, the magnetic template generating one or more magnetic fields;
with the substrate in proximity of the magnetic template, applying a coating material to the second side of the substrate, the coating material including particles of a magnetically responsive material and a polymer, the one or more magnetic fields penetrating through the substrate and through the second side such that the one or more magnetic fields magnetically interacts with the magnetically responsive material, the one or more magnetic fields causing the magnetically responsive material to commonly orient in one or more localized regions on the substrate;
curing the coating material while the magnetically responsive material is maintained in the common orientation to produce an optical effect coating on the substrate, the polymer of the optical effect coating locking the magnetically responsive material in the common orientation in the localized regions, the common orientation of the magnetically responsive material producing an optical effect of the optical effect coating.

14. The process as recited in claim 13, wherein the magnetic template includes magnetic elements arranged in a pattern.

15. The process as recited in claim 14, wherein the magnetic elements are commonly oriented with respect to their north and south poles.

16. The process as recited in claim 14, wherein the curing is conducted by heating the magnetic template, substrate, and coating material, and the heating is limited to a temperature below the Curie temperature of the magnetic elements.

17. The process as recited in claim 13, wherein the substrate is leather.

18. The process as recited in claim 17, wherein the particles of the magnetically responsive material include at least one of iron or cobalt.

19. The process as recited in claim 18, wherein the polymer is selected from the group consisting of polyurethane, polyether, polyester, acrylic, and combinations thereof.

20. The article as recited in claim 18, wherein the polymer has a glass transition temperature that is less than or equal to −0° C.
